(19) United States
(12) Patent Application Publication
(10) Pub. No.: US 2003/0188040 A1
(43) Pub. Date: Oct. 2, 2003

(54) Software agent hosting environment with extensible middleware integration

(75) Inventor: Christopher R. Vincent, Arlington, MA (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, Armonk, NY

(21) Appl. No.: 10/112,245

(22) Filed: Mar. 29, 2002

(51) Int. Cl. G06F 9/44

(52) U.S. Cl. 709/317

(57) ABSTRACT

A structured software agent hosting environment that supports installing software agents, runtime environments and agent software extensions along with bindings of those objects that are to occur at runtime. According to a method that is provided for hosting software agents, there is accepted an agent package associated with an agent. The agent package includes an agent module, a runtime specification and zero or more extension specifications. The runtime specification specifies a runtime module required by the agent module. The agent module is prepared for execution, and there is stored a runtime reference that includes an association of the runtime specification and the agent module. This allows a single software agent manager to provide uniform security processing, agent maintenance functionality and operational control of agents that are developed with a variety of software tools and that operate under disparate runtime environments.

### BACKGROUND OF THE INVENTION

1. Field of the Invention

The present invention relates to computer program hosting, and more specifically to a system and method for providing a flexible environment to deploy and maintain executable computer programs.

2. Description of Related Art

The software term “agent” is used to describe small, simple programs that act on behalf of a user, semi-autonomously, and/or work together to accomplish high-level goals. Examples of agents include small software programs that are developed in a scripting language, such as Javascript or Perl, or that are developed in more conventional computer programming languages such as C++, Java or FORTRAN. Agents are used to perform simple but fundamental tasks that aid individuals that use computers. Example tasks that are performed by software agents include the following.

1) A meeting scheduler that manages the process of arranging a meeting between a number of people with changing constraints.

2) A program that logs onto an instant messaging service to provide specialized services, such as directory lookup functions or message forwarding.

3) Workflow escalation agents that remind users when they need to attend to urgent business matters.

Software agents perform specialized tasks that often have many different applications. A software agent that performs one task may be useful to process data from multiple sources. A data transformation agent may be used to transform data retrieved from a database or from an on-line data source that has a significantly different interface design than a database. Although the data transformation processing is the same, processing to obtain input data and dispatch output data are different and implementation of the same transformation processing for these two data sources requires additional development. Requesting processing from a variety of sources and implementing the external interface processing for a variety of platforms and environments further increases the development burden for these agents. Modular software designs are used to reduce the development effort required to implement flexible agents that support a variety of interfaces by separating the data processing from the interface processing and reusing much of the interface processing modules for different data processing modules. The use of modular software, however, does not completely remove the requirement to modify the data processing design to accommodate different interfaces.

Many agents that perform simple processing tasks are designed to have an instance of that agent execute for only the time duration of the requested action. In the operation of these agents, a user or computer process requests the action of an agent and an instance of that agent then is created to perform that action. Once the action is complete, the instance of the agent is terminated. In these environments, an agent that performs a task in response to a request by a user returns a data set to the user through the same communications channel as was used to communicate the request. These architectures require the user to maintain the communications channel to the agent until the processing of the agent is complete.

Business enterprises often simultaneously maintain software agents that are developed for a variety of environments or software platforms. For example, software agents developed to operate in environments or software platforms for Perl, Java 2 Enterprise Edition (J2EE), conventional computer languages and a large number of other development standards frequently coexist on an enterprise's computer system and must all be maintained. Each of these environments or software platforms typically have their own management environment and tools that do not interact with the management environments or tools of other environments or software platforms. These multiple environments or platforms often also implement their own security processing and other maintenance functions. The security processing available with the different environments or platforms may also not be equivalent and thus can result in different levels of security being available based upon the environment or platform used by the agent. Having the security processing distributed among several platforms or environments also requires additional effort to configure, and reconfigure, all of the platforms or environments to provide the security that is required.

While an enterprise may require that all agents be developed under a single environment, this limits the ability of the enterprise to use existing agents that were developed under other environments. Restricting agents to a single environment also reduces the flexibility of agent designs that might be more efficiently developed under other environments.

### SUMMARY OF THE INVENTION

In view of these drawbacks, it is an object of the present invention to remove the above-mentioned drawbacks and to provide systems and methods for a software agent hosting environment with extensible middleware integration.

One embodiment of the present invention provides a method for hosting software agents. According to the method, there is accepted an agent package associated with an agent. The agent package includes an agent module, a runtime specification, and zero or more extension specifications, and the runtime specification specifies a runtime module required by the agent module. The agent module is prepared for execution, and there is stored a runtime reference that includes an association of the runtime specification and the agent module.

Another embodiment of the present invention provides a software agent manager that includes an agent package input, an agent module preparer, and a runtime reference database. The agent package input accepts an agent package associated with an agent. The agent package includes an agent module, a runtime specification and zero or more extension specifications, and the runtime specification specifies a runtime module required by the agent module. The agent module preparer prepares the agent module for execution, and the runtime reference database stores a runtime reference that includes an association of the runtime specification and the agent module.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 is a data diagram of an exemplary agent package in accordance with an exemplary embodiment of the present invention;

FIG. 2 is a schematic diagram of a software agent hosting environment in accordance with an exemplary embodiment of the present invention;

FIG. 3 is a data object diagram for the databases used to store software agents and associated modules in accordance with an exemplary embodiment of the present invention;

FIG. 4 illustrates a runtime specification XML document in accordance with an exemplary embodiment of the present invention;

FIG. 5 illustrates an extension specification XML document in accordance with an exemplary embodiment of the present invention;

FIG. 6 illustrates an agent specification XML document in accordance with an exemplary embodiment of the present invention;

FIG. 7 is a processing flow diagram illustrating the agent installation processing flow in accordance with an exemplary embodiment of the present invention; and

FIG. 8 is a processing flow diagram illustrating the agent instance creation processing flow in accordance with an exemplary embodiment of the present invention.

### DETAILED DESCRIPTION OF PREFERRED EMBODIMENTS

Preferred embodiments of the present invention will be described in detail hereinbelow with reference to the attached drawings.

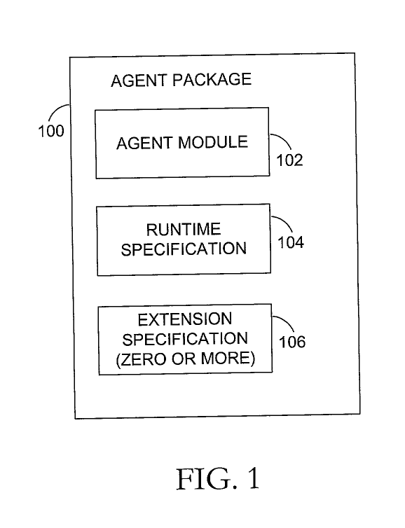

The exemplary embodiments of the present invention receive and manage software agents that are developed under a variety of development environments and platforms. Agents utilized by the exemplary embodiments of the present invention are contained within agent packages. An exemplary agent package 100, according to an exemplary embodiment of the present invention, is shown in FIG. 1. Agents used by the exemplary embodiments of the present invention are implemented with a modular design that contains an agent module 102, a runtime specification 104 and an extension specification 106. The agent module 102 of the exemplary embodiment contains the program instructions for performing the action associated with that agent. The agent module 102 of various embodiments contains either source code or program data in another format to define the processing performed by the particular agent. The agent module contains software to perform a task and is designed to execute in a particular runtime environment. The runtime specification 104 of the exemplary agent package 100 specifies the runtime environment in which the agent module 102 is to execute. Examples of the runtime specification 104 include a Javascript runtime environment, a Perl runtime environment or any other runtime environment required by the particular agent module 102.

Agent package 100 also contains zero or more extension specifications that identify and specifies extensions that the agent module 102 is able to use. Extensions within the exemplary embodiments of the present invention are software modules that provide expanded functionality to software agents. Examples of extensions include software modules that perform processing to implement interfaces between the processing of the agent module 102 and external software processes such as databases, instant messaging services and other so-called “middleware” applications. The extension specification 106 is also able to specify no extensions to indicate that the agent module does not utilize extensions. Alternative embodiments are able to make the extension specification 106 optional within agent package 102. A list of extensions is also able to be provided as is described below.

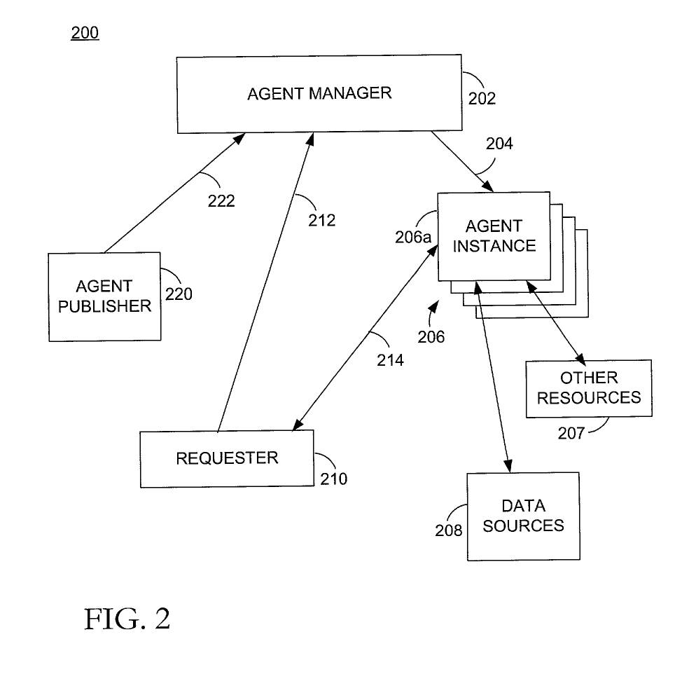

An example software agent hosting environment 200 according to an exemplary embodiment of the present invention is shown in FIG. 2. The software agent hosting environment has an agent manager 202 that manages and controls the execution of the software agents in this exemplary embodiment. The software agents utilized by this exemplary embodiment are able to be developed in a large variety of environments or platforms. Agents are able to be developed in high level languages such as Javascript, Perl, C++, Java or FORTRAN, or in any other environment. Once agents are developed, an agent publisher 220 creates an agent package 100 that is communicated by the agent publisher 220 to the agent manager 202 over communications link 222 for installation into the agent manager 202. Communications link 222 of the exemplary embodiment allows the agent publisher 220 or another process to remotely install, query and manage the agents installed within the agent manager 202. The exemplary embodiment utilizes web services based upon the Simplified Object Access Protocol (SOAP) and Java Remote Method Invocation (RMI) to perform these tasks. Alternative embodiments use other protocols and communications means to implement the tasks of installing, querying and managing the installed agents.

Agent manager 202 accepts, over request link 212, service requests from a requester 210 that are to be performed by a software agent installed within the agent manager 202. The agent manager 202 of the exemplary embodiment is able to interact with a large number of requesters that are of many types. A requester 210 is able to be an individual user of a computer using a software application such as a specialized software application or an HTTP based web browser. A requester 210 is also able to be a computer program or process that is configured to request software agent services through the agent manager 202.

Once the agent manager 202 of the exemplary embodiment receives a service request from a requester 210, the agent manager 202 creates an instance 206a of the required agent. The agent manager 202 of the exemplary embodiment is able to create and manage a large number of executing agent instances 206, of which a particular agent instance 206a is used to satisfy a particular service request. In order to satisfy the service request, the agent instance 206a in this example is configured to operate with the required extensions. The agent manager in this embodiment configures the agent instance 206a to operate with the extensions that were specified by the agent developer. The exemplary embodiment utilizes extensions to allow an agent module 102 to communicate with data sources 208 such as SQL database managers, workplace collaboration software such as Lotus Domino (available from International Business Machines Corporation) and other data sources. Agent modules are also able to communicate with individuals or other processes via various communications means such as internet communications, instant messaging (including instant messaging provided by the Lotus Sametime software product available from International Business Machines Corporation). Extensions are able to be developed that implement interfaces to a wide variety of software processing components and computer processing services that are either hosted on the same computing system or that are hosted remotely from the executing agent module 102.

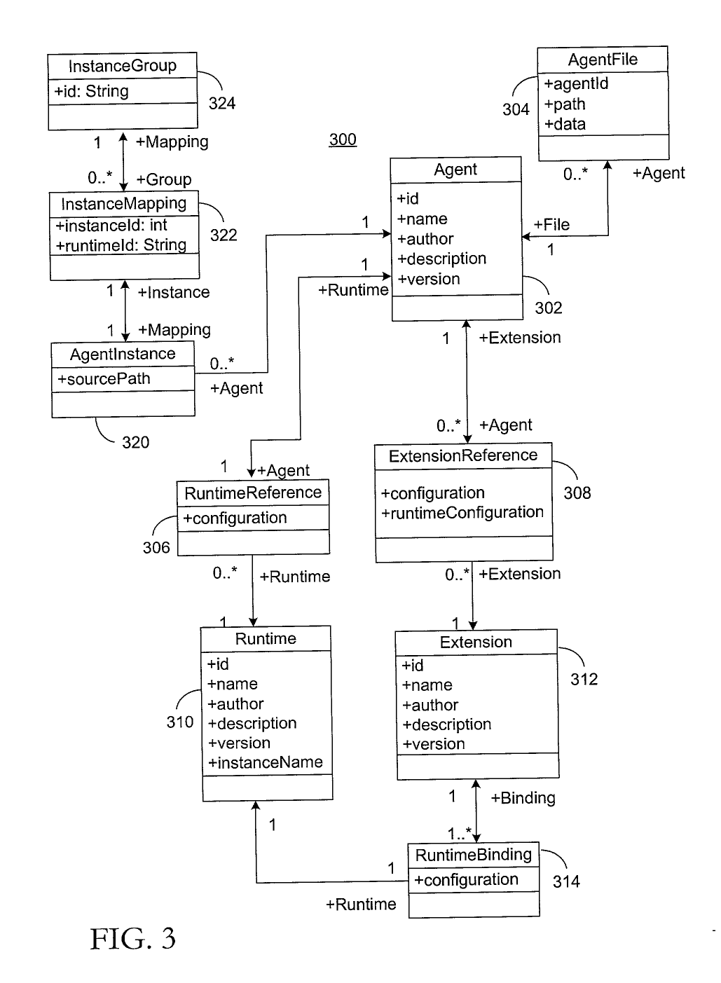

The exemplary embodiments of the present invention are able to store and represent agents, runtimes, and extensions, as well as currently executing instances of agents in the system, as object oriented database elements. This representation also illustrates the relationships between these objects. An exemplary agent hosting environment object diagram 300 is illustrated in FIG. 3. The objects of the exemplary agent hosting environment object diagram 300 are stored in one or more databases within the exemplary embodiment of the present invention. Each type of object is able to be stored in a separate database for that type of object, i.e., ExtensionReference objects 308 are able to be stored in an extension reference database. Alternative embodiments are also able to store different types of objects in a single database.

An agent object 302 of this exemplary embodiment is shown to include a number of descriptive fields that facilitate identification and maintenance of the agent object 302. The fields within the exemplary agent object 302 of this exemplary embodiment include fields for an id or identification, a name, an author, a description and a version. The identification field is able to contain a number or an alphanumeric name that uniquely identifies the agent object 302 to the software agent hosting environment and allows a large number of agent packages to be uniquely identified and handled by the software agent hosting environment. The name field allows a descriptive name to be assigned to the agent. The author field allows the name of an author to be provided to assist in the identification of the source of that agent. The description field allows an alphanumeric text block to be provided that describes the functions, operations and other data about the agent. A version field allows the version of the agent to be specified in order to facilitate agent maintenance.

The agent object 302 has a link to an AgentFile object 304. This link allows one agent object 302 to be mapped to zero or more AgentFile objects 304. The AgentFile object of this exemplary embodiment of the present invention specifies the data file that contains the executable software to perform the processing for the agent. The AgentFile object 304 allows specification of an agentId to uniquely identify the particular AgentFile object 304 and support maintenance of the multiple AgentFile objects installed within the agent manager 202. The exemplary AgentFile object 304 further has fields to specify a path to the object code and a data field to allow specification of data associated with the particular AgentFile object 304.

The agent object 302 has a link to a RuntimeReference object 306. This link allows one agent object 302 to be mapped to one RuntimeReference object 306. The RuntimeReference object 306 of this exemplary embodiment of the present invention contains a field that specifies the configuration of the Runtime that is used with the Agent 302. The RuntimeReference object 306 has a link to one Runtime object 310. An agent object 302 has zero or more AgentFile objects 304 that contain executable software to perform the processing for the agent. The executable software associated with the AgentFile objects 304 are configured to execute under a particular runtime environment, such as Javascript, Perl, or other environment. The link from the Agent object 302 to the RuntimeReference object 406, which in turn identifies a Runtime object 310, serves to identify the runtime environment to be used to execute the agent 302. The RuntimeReference object allows specification of particular configuration parameters, via the configuration field within the RuntimeReference object 306, in order to ensure proper execution of the agent executable code associated with the AgentFile 304.

The RuntimeReference object 306 has a link to one Runtime object 310. Each runtime object 310 is able to have links to zero or more RuntimeReference objects 306, and thus each runtime is able to support multiple agent objects 302. The Runtime object 310 is associated with runtime environments to be used with the agents supported by the agent manager 202, such as a Javascript environment, a Perl runtime environment, a C++ runtime environment including dynamic libraries, as well as other runtime environments. The Runtime object 310 contains fields to specify the id or identification of the Runtime object 310. The id field of the exemplary embodiment is able to be an alphanumeric field or a numeric field. The Runtime object 310 of the exemplary embodiment includes a name field to provide a descriptive name for the runtime environment associated with the Runtime object 310, an author field to identify the author of the Runtime object, a description field to provide a textual description of the Runtime object 310, a version field to identify the version of the Runtime object 310 in order to facilitate maintenance and other operations with the Runtime object 310, and an instanceName of the Runtime object that identifies the instance of the runtime environment associated with the particular Runtime object 310.

The agent object 302 has a link to zero or more ExtensionReference objects 308. This link allows one agent object 302 to be mapped to zero or more ExtensionReference objects 308 and there is one ExtensionReference object 308 for each extension that the agent object 302 requires. Extensions used by the exemplary embodiment of the present invention allow flexible integration of the software that performs the core processing of the agent with a variety of user interfaces, data sources, and other interfaces that are present in the computational environment in which the agent manager 202 operates. The Extension reference has a link to one Extension object 312, which is described below. Each Extension object 312 is able to be linked to zero or more ExtensionReference objects 308, which in turn are associated with an Agent object 302. The ExtensionReference object 308 of the exemplary embodiment supports specification of configuration parameters within the configuration field of the ExtensionReference object 308. Specification of extension configuration parameters in the ExtensionReference object 304 allows proper configuration of the extension for proper operation with the agent associated with agent object 302 while allowing an Extension object 312 to operate with multiple agent objects 302 that each require different configurations of the Extension object 312.

Each Extension object 312 is associated with an extension to be used with zero or more agents. Extension objects 312 are able to contain executable software to implement interfaces or other processing for the agent object 302. Each Extension object 312 is able to be linked to zero or more ExtensionReference objects 308. This advantageously allows extension code to be reused with multiple agent objects 302. Extension objects 312 are able to have configuration parameters to alter the processing of the executable code of the Extension object 312. This architecture allows Extension objects 312 to be modified in order to support different agents by utilizing configuration data to cause the modifications to be implemented. The Extension object 312 includes fields to specify an id or identification of the Extension object 312, a name, author, description and version of the particular Extension object 312. The name field allows a descriptive name for the Extension object 312 to be specified, and the author field, as with the author fields of the other objects in this description, is able to identify the author or corporate source of the Extension object 312 in order to support maintenance and source tracking of the object. The description field allows a description of the particular Extension object 312 and the version field is used to provide version data in order to facilitate maintenance of the Extension object and the software agent hosting environment in general. Each Extension object 312 has a link to one or more RuntimeBinding objects 314. Each RuntimeBinding object 314 is linked to a Runtime object 310. The linking to multiple RuntimeBinding objects 314 supports extension architectures wherein each extension is able to operate with multiple runtime objects 310. The RuntimeBinding object 314 identifies with which runtimes the associated extension object 312 is able to operate. This advantageously allows for reuse of Extension objects 312 with multiple agent objects 302 that operate with different Runtime environments.

Each RuntimeBinding object 314 is a binding between an Extension object 312 and a Runtime object 310. The RuntimeBinding object 314 contains a field to specify configuration data for the Runtime object 310. This allows the Runtime object 310 to be properly configured to operate with the associated Extension object 312.

The database objects and associated links that are described above are established in the exemplary embodiment of the present invention when an agent object 302 is installed within the agent manager 202. Once these objects and links are installed, an instant of the particular agent object 302 is able to be created. For each instance of a particular agent object 302, an AgentInstance object 320 is created. The AgentInstance object 320 has a link to one agent object 302 that identifies the particular agent object 302 of the created instance. Each agent object 302 is able to have a links to zero or more AgentInstance objects 320. Zero links from an agent object 302 to AgentInstance objects 320 indicates that no instances of that object exist at that time. Each AgentInstance object 320 of the exemplary embodiment, which executes in a Javascript environment, has a field to specify a sourcePath for the Agent object 320.

Each instance of an agent in the exemplary embodiment of the present invention is associated with an InstanceGroup object 324. The InstanceGroup object 324 allows grouping of agent instances to facilitate maintenance of the various instances of agents within the agent manager 202. Each Instancegroup object 324 of the exemplary embodiment supports, for example, specification of different security parameters for the agent instances that are associated with that InstanceGroup object 324. Each InstanceGroup 324 has an id or identification string that supports unique identification of the particular InstanceGroup object 324. Each InstanceGroup object 324 is also able to have a link to zero or more InstanceMapping objects 322 that are associated with each agent instance that is associated with the InstanceGroup object 324. The InstanceMapping object 322, in turn, is associated with one AgentInstance object 320.

InstanceMapping objects 322 are used to map an AgentInstance object 320 to one InstanceGroup object 324. The InstanceMapping object 322 contains an instanceId field to identify the instance of the agent and a runtimeId field to identify the runtime under which the agent instance is operating. The instances of the exemplary embodiments are able to use different runtime objects and the instances that use different runtime objects are stored in different database tables. The InstanceMapping objects 322 provide a mapping of instances that use different runtime objects.

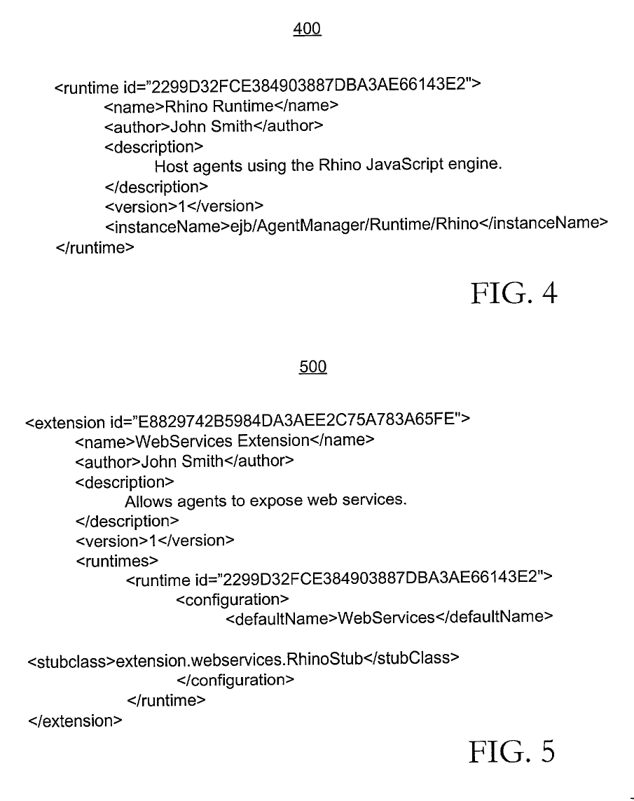

The software agent manager of the exemplary embodiment specify objects and relationships between the objects that are to be installed in and hosted by the agent manager via XML document files. An exemplary runtime specification 400 of an exemplary embodiment of the present invention is illustrated in FIG. 4. The exemplary runtime specification 400 defines the data fields associated with Runtime object 310. The exemplary runtime specification 400 is shown to have a runtime id that contains an alphanumeric string that is a unique identification of the particular Runtime object 310. The runtime id in the exemplary embodiment of the present invention is established when the runtime is installed on the agent manager 202. The exemplary runtime specification 400 of the exemplary embodiment also contains an author, description and version field that are defined by the developer of the runtime object in the exemplary embodiment. The exemplary runtime specification 400 also contains a field describing the instanceName. In an example using a J2EE application, the instance name is the data provided by the Java Naming and Directory Interface (JNDI) for the entity bean home that is associated with the runtime's agent instance implementation.

An exemplary extension specification 500 of an exemplary embodiment of the present invention is illustrated in FIG. 5. The exemplary extension specification 500 defines the data fields associated with Extension object 312. The exemplary extension specification 500 is shown to have an extension id that contains an alphanumeric string that is a unique identification of the particular Extension object 310. The extension id in the exemplary embodiment of the present invention is established when the extension is installed on the agent manager 202. The exemplary extension specification 500 of the exemplary embodiment also contains a name, author, description and version field that are defined by the developer of the runtime object in the exemplary embodiment. The exemplary extension specification 500 includes a runtimes specification field that identifies the runtime objects with which the Extension object 308 is able to operate along with a specification of the configuration of that runtime that is required for proper operation of the extension.

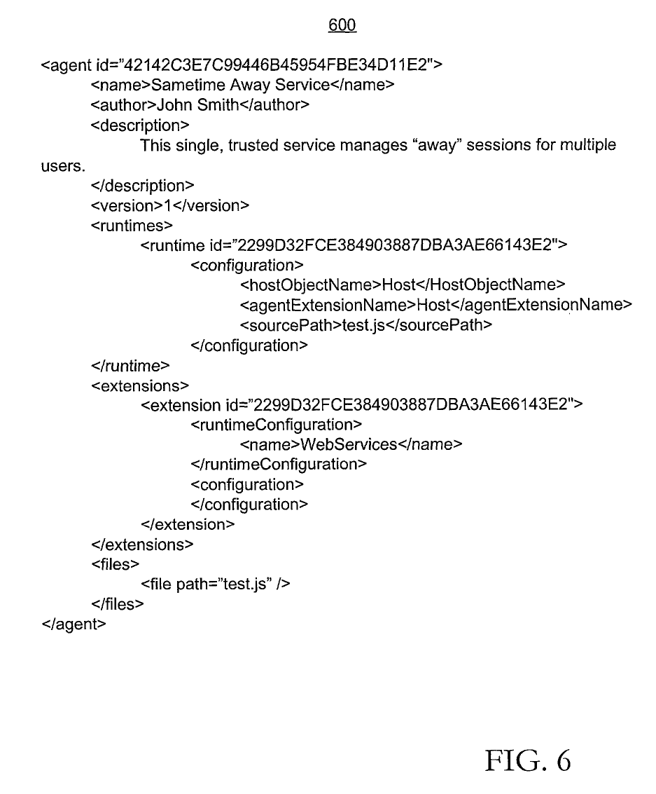

An exemplary agent specification 600 of an exemplary embodiment is illustrated in FIG. 6. The exemplary extension specification 600 defines the data fields associated with agent object 302. The exemplary agent specification 600 is shown to have an agent id that contains an alphanumeric string that is a unique identification of the particular agent object 302. The agent id in the exemplary embodiment of the present invention is established when the agent is installed on the agent manager 202. The exemplary agent specification 600 of the exemplary embodiment also contains a name, author, description and version field that are defined by the developer of the runtime object in the exemplary embodiment. The exemplary agent specification 600 includes a runtimes specification field that identifies the runtime objects 310 with which the agent object 302 is able to operate along with a specification of the configuration of that runtime. The exemplary agent specification 600 also includes an extension specification field that identifies the extension objects 312 with which the agent object 302 is able to operate along with a specification of the configuration of that runtime. The exemplary agent specification 600 includes a files field that allows specification of the AgentFile object 304.

Agent Installation in Agent Environment

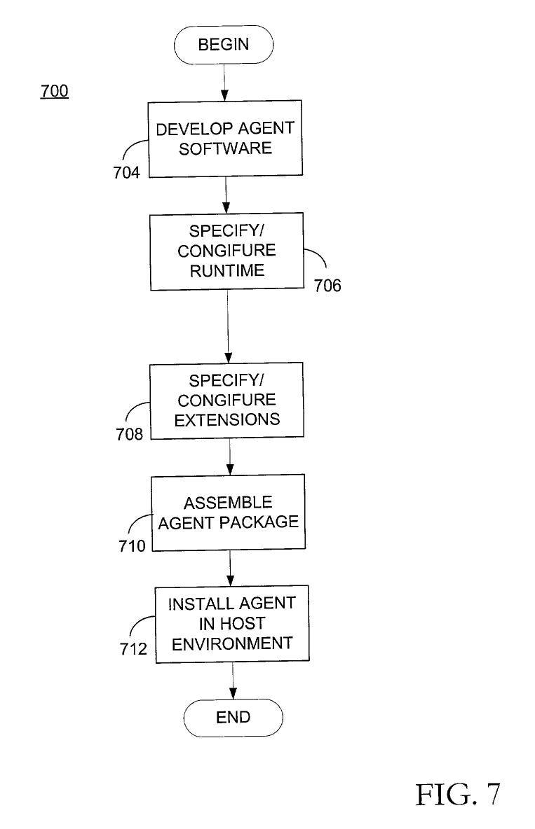

The agent development and installation processing flow 700 of an exemplary embodiment of the present invention is illustrated in FIG. 7. The processing to be performed by an agent is defined in the agent module that is developed, at step 704, by a software or script developer. The agent modules are the source code that is associated within the AgentFile object 304 of the exemplary embodiment. The agent modules of the exemplary embodiment are developed using any of a variety of environments that include Javascript, Perl, C++, FORTRAN or any other suitable development environment. The structure of the exemplary embodiment of the present invention, which allows specification of agent objects that identify and resolve at runtime not only the AgentFile object 304 but also the Runtime object 310 and Extension objects 312, support the flexible use of this variety of development environments for the development of agents. This advantageously allows agent developers to select a development environment that is best suited to the problem solved by the agent rather than limiting development environments to the common runtime environment of the enterprise for which the agent is developed.

Once an agent module itself is developed, the developer is able to use existing extensions, or the developer is able to develop or modify extensions to be used with the agent. The extensions of the exemplary embodiments are predefined by a third party but a developer is able to modify an extension in special cases. The developer specifies and configures, at step 706, the runtime modules that are required by the agent module. The exemplary embodiments of the present invention support reusable extensions that are able to be used by a number of agent modules. Extensions are able to be configured or modified in order to support different module features. The developer specifies, at step 708, the extensions that are required by the agent module. The developer is also able to specify configuration data for those extensions at this point. Extensions are able to use the extension configuration data contained in the ExtensionReference object 308 that is linked to the agents in order to select and configure the extension's features.

When the agent module and any new or modified extensions are ready for deployment, the developer assembles, at step 710, an agent package. The agent package includes the definition of the agent object 302 as is illustrated in the exemplary agent specification 600. Assembly of the agent package in the exemplary embodiment includes preparation of an agent specification file using an XML document such as the exemplary agent specification 600. This agent specification file identifies the Runtime object 310 as well as Extension objects 312 that are able to be used with this agent object 302. The agent specification further identifies the file that contains the executable code to implement the specialized agent processing, as is illustrated in the exemplary agent specification 600.

The runtime objects 310 and extension objects 312 in the exemplary embodiment are predefined and are installed prior to installation of the agent objects 302. Alternative embodiments of the present invention allow the assembly of an agent package to include the specification of any new or modified Extension objects 312 that were developed as part of this process. Extension objects are defined in the exemplary embodiment with XML document such as the exemplary extension file 500. Once the agent package is assembled, the agent, by means of the agent package of the exemplary embodiment, is ready to be installed, at step 712, into the agent hosting environment. Installation of the agent package in the agent hosting environment of the exemplary embodiment of the present invention includes installing the agent object 302, AgentFile objects 304, the RuntimeReference object 306, and the ExtensionReference 308 into the databases of the agent manager 202. The agent package in the exemplary embodiment of the present invention is electronically communicated to the agent manager 202. The agent manager 202 of the example embodiment utilizes a Simplified Object Access Protocol (SOAP) or Java RMI interface to support installation of agents, as well as to support management and status querying of the installed agents. It is to be noted that these objects are conceptual notions used to illustrate the database design and the structure of the interaction among the agent objects, extension objects and runtime objects within the exemplary embodiment of the present invention. The actual structure of data elements, specification files and other structures in the exemplary embodiment or alternative embodiments of the present invention are able to reorganize these data elements and links and still be consistent with the teachings of the present invention. Installation of executable software in the agent manager 202 is able to also include compilation of source code or other preparation of executable software modules for execution by the agent manager 202. Installation of the agent package into the software agent runtime environment further consists of establishing values for some data items within the installed objects. For example, the id or identification values of the above installed objects, such as the id value within the agent object 302, are established during agent installation. The links among these installed objects, such as among the agent object 302, ExtensionReference object 308 and Extension object 312, are also created during the installation of an agent within the exemplary embodiment. After the agent package is installed into the software agent hosting environment, the processing performed to install an agent stops.

Agent Instance Creation

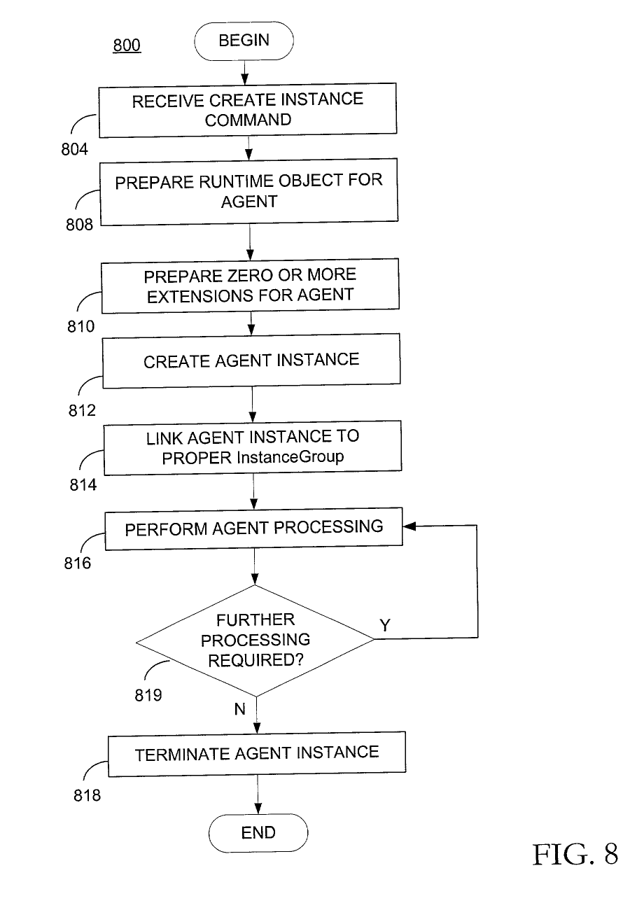

The create agent instance processing flow 800 of an exemplary embodiment of the present invention is illustrated in FIG. 8. The create agent instance processing flow 800 begins with the receipt, at step 804, of a command to create an instance of a specific agent. The exemplary embodiment recognizes a “Create_Insance” command that allows specification of the agent id, the instance group and configuration of the agent. The receipt of a create instance command by a command receiver within the agent manager 202 results in the software agent manager 202 locating the agent that is to be instantiated. Once the agent to be instantiated is located, the processing then prepares, at step 808, the runtime object 310 to support execution of the identified agent. Preparation of the runtime object 310 in the exemplary embodiments of the present invention includes ensuring that the runtime object 310 is configured with the runtime configuration data specified within, for example, the RuntimeReference object 306, the ExtensionReference object 308 and the RuntimeBinding object 314. Once the runtime object 310 is properly prepared, the agent manager 202 of the exemplary embodiment prepares the one or more extensions required by the agent and agent for execution, at step 810. If more than one extension is required, the exemplary embodiment iteratively prepares each extension individually. The preparation of extensions in the exemplary embodiment includes configuring the extensions with the extension configuration data contained in, for example, the ExtensionReference object 308. After the extensions are prepared, the agent instance itself is created, at step 812, by an agent instance manager within the agent manager 202. Creation of the agent instance in the exemplary embodiments includes creating links to already operating extensions and/or creating instances of required extensions that are not operating prior to creating this agent instance. After, or as part of, the creation of the instance of the agent, the agent manager 202 links, at step 814, the newly created agent instance to the proper instance group 324. The agent then performs, at step 816, the processing for the requested service. The exemplary embodiments of the present invention allow instances of agents to persist for periods longer than the immediate transaction that caused the creation of the agent instance. Such agents are able to communicate, for example, via e-mail or instant messaging applications to a user to provide a response according to the processing of that agent. The agent manager 202 monitors the execution of the agent instance. Once an initial iteration of the agent is performed, the processing then determines, at step 819, if further processing is required by the agent. If further processing is required, the processing of the agent is again performed, at step 816. If further processing is not required, the agent manager 202 terminates, at step 818, this instance of the agent.

Instances of agents within the exemplary embodiments of the present invention are able to persist beyond a single transaction. Once an instance of an agent is created, the agent is able to either perform a single task and terminate, or the instance of the agent is able to persist past a single transaction and perform tasks at times beyond the time frame of the creation of the instance. For example, an agent is able to be developed to notify a user or other computer process of a modification within a database. An instance of the agent is able to be created in response to a user requesting a notice of when a database is modified. An agent is selected that causes an e-mail to be sent to the requesting user when the specified database is modified. The transaction for this notification is limited to the creation of the agent, but the agent persists and notifies the user when the database is modified without further interaction by the user. The exemplary embodiment of the present invention advantageously allows simple scripts or agent programs to be developed and operate persistently without the difficulties associated with the development and management of daemons or other persistent program. In particular, the exemplary embodiments of the present invention support the use of long-lived agents in a structured hosting environment.

Agent Security Processing

The agent manager of the exemplary embodiments manages security processing for all agents that are installed and that are managed by that manager. Security processing includes developing rules based systems that govern instance/agent administrations, e.g., a certain group of people are allowed to destroy instances created other groups. The exemplary embodiments of the present invention advantageously provide uniform security processing to all agents regardless of the agent's runtime environment, language or other factors. This allows uniform security parameters to be established, modified and otherwise maintained for all agents regardless of the agent's runtime environment. This contrasts favorably with a system administrator's managing security processing of multiple agent environments, such as separate environments for Javascript, Perl, C++ packages, HTTP modules and other environments. The use of a single software agent hosting environment that incorporates a single security architecture for all agent modules further facilitates distribution of security policies to different facilities or the adaptation of existing security policies that are to be slightly modified for use in the other facility. Examples of such security policies include a security policy that specifies a group of people that may use instant messaging in the agent instances that they create, and a security policy that limits a group of users to a subset of servers. These security policies are established and enforced by the single agent manager 202 regardless of the runtime used by a particular agent.

Agent Maintenance Processing

The exemplary embodiments of the present invention advantageously provide a single agent hosing environment that allows maintenance of all software agents through this single hosting environment. This single hosting environment is used to maintain and manage software agents that are developed and that execute in a variety of development and runtime environments. This compares advantageously to the conventional software agent maintenance structure of a large organization where the large number of agents used by that organization are maintained under the several hosting environments that are particularized to the runtime or development environment of the agents that are installed in that particularized host.

The exemplary embodiments of the present invention support agent development in a variety of development environments while supporting a uniform software agent hosting environment for installing, maintaining and managing the use of software agents in a heterogeneous computer environment. The exemplary embodiments advantageously provide a database structure to link software agent executables to their runtime environments and a database of associated processing extensions.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when loaded and executed, controls the computer system such that it carries out the methods described herein.

The present invention can also be embedded in a computer program product, which comprises all the features enabling the implementation of the methods described herein, and which—when loaded in a computer system—is able to carry out these methods. In the present context, a “computer program” includes any expression, in any language, code or notation, of a set of instructions intended to cause a system having an information processing capability to perform a particular function either directly or after either or both of the following: a) conversion to another language, code, or notation; and b) reproduction in a different material form.

Each computer system may include one or more computers and a computer readable medium that allows the computer to read data, instructions, messages, or message packets, and other computer readable information from the computer readable medium. The computer readable medium may include non-volatile memory such as ROM, Flash memory, a hard or floppy disk, a CD-ROM, or other permanent storage. Additionally, a computer readable medium may include volatile storage such as RAM, buffers, cache memory, and network circuits. Furthermore, the computer readable medium may include computer readable information in a transitory state medium such as a network link and/or a network interface (including a wired network or a wireless network) that allow a computer to read such computer readable information.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for hosting software agents, the method comprising:
accepting an agent package associated with an agent, the agent package including an agent module and a runtime specification, the runtime specification specifying a runtime module required by the agent module;
preparing the agent module for execution; and
storing a runtime reference that includes an association of the runtime specification and the agent module.

2. The method as defined in claim 1, wherein the agent package also includes at least one extension specification.

3. The method as defined in claim 2, further comprising the step of storing at least one extension reference that includes associations between the agent module and at least one extension, the at least one extension being specified in the extension specification.

4. The method as defined in claim 3, wherein the extension specification includes a specification of runtime modules with which an extension operates.

5. The method as defined in claim 2, wherein the extension specification specifies no extensions.

6. The method as defined in claim 1, further comprising the step of creating an instance of the agent associated with the agent module.

7. The method as defined in claim 6, further comprising the step of linking the instance of the agent associated with the agent module to at least one extension.

8. The method as defined in claim 1, further comprising the steps of:
accepting a command to create an instance of the agent associated with the agent module;
creating the instance of the agent module for execution in conjunction with the runtime module specified by the runtime specification for the agent; and
terminating the instance upon completion of processing by the instance.

9. The method as defined in claim 8, wherein the command is communicated via a user connection and the terminating step is performed after closure of the user connection.

10. A software agent manager comprising:
an agent package input for accepting an agent package associated with an agent, the agent package including an agent module and a runtime specification, the runtime specification specifying a runtime module required by the agent module;
an agent module preparer for preparing the agent module for execution; and
a runtime reference database for storing a runtime reference that includes an association of the runtime specification and the agent module.

11. The software agent manager as defined in claim 10, wherein the agent package also includes at least one extension specification.

12. The software agent manager as defined in claim 11, further comprising an extension reference database for storing at least one extension reference that includes associations between the agent module and at least one extension, the at least one extension being specified in the extension specification.

13. The software agent manager as defined in claim 12, wherein the extension specification includes a specification of runtime modules with which an extension operates.

14. The software agent manager as defined in claim 11, wherein the extension specification specifies no extensions.

15. The software agent manager as defined in claim 10, further comprising an agent instance creator for creating an instance of the agent associated with the agent module.

16. The software agent manager as defined in claim 15, wherein the agent instance creator links the instance of the agent associated with the agent module to at least one extension.

17. The software agent manager as defined in claim 10, further comprising:
a command receiver for accepting a command to create an instance of the agent associated with the agent module; and
an agent instance manager for creating the instance of the agent module for execution in conjunction with the runtime module specified by the runtime specification for the agent, and for terminating the instance upon completion of processing by the instance.

18. A machine-readable medium encoded with a program for hosting software agents, the program containing instructions for:
accepting an agent package associated with an agent, the agent package including an agent module and a runtime specification, the runtime specification specifying a runtime module required by the agent module;
preparing the agent module for execution; and
storing a runtime reference that includes an association of the runtime specification and the agent module.

19. The machine-readable medium as defined in claim 18, wherein the agent package also includes at least one extension specification.

20. The machine-readable medium as defined in claim 19, wherein said program further contains instructions for storing at least one extension reference that includes associations between the agent module and at least one extension, the at least one extension being specified in the extension specification.

21. The machine-readable medium as defined in claim 20, wherein the extension specification includes a specification of runtime modules with which an extension operates.

22. The machine-readable medium as defined in claim 19, wherein the extension specification specifies no extensions.

23. The machine-readable medium as defined in claim 18, wherein said program further contains instructions for creating an instance of the agent associated with the agent module.

24. The machine-readable medium as defined in claim 18, wherein said program further contains instructions for:
accepting a command to create an instance of the agent associated with the agent module;
creating the instance of the agent module for execution in conjunction with the runtime module specified by the runtime specification for the agent; and
terminating the instance upon completion of processing by the instance.
